(19) United States
(12) Patent Application Publication
(10) Pub. No.: US 2010/0164146 A1
(43) Pub. Date: Jul. 1, 2010

(54) IMPRINTING MOLD AND PATTERN FORMATION METHOD

(76) Inventors: Yohko FURUTONO, Tokyo (JP); Ryoichi Inanami, Yokohama-shi (JP); Hiroshi Nomura, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/646,683

(22) Filed: Dec. 23, 2009

(30) Foreign Application Priority Data
Dec. 26, 2008 (JP) 2008-333077

(51) Int. Cl. B29C 59/16; B28B 11/08; B29C 59/02

(52) U.S. Cl. 264/446; 425/385; 264/293

(57) ABSTRACT

An imprint mold includes a substrate, a concave and convex pattern provided on the substrate and corresponding to a pattern to be transferred, and a gas permeable region having higher gas permeability than molten quartz in which impurities are not doped.

### CROSS-REFERENCE TO RELATED APPLICATIONS

This application is based upon and claims the benefit of priority from prior Japanese Patent Application No. 2008-333077, filed Dec. 26, 2008, the entire contents of which are incorporated herein by reference.

### BACKGROUND OF THE INVENTION

1. Field of the Invention

The present invention relates to an imprinting mold for use in imprint lithography, and a pattern formation method using the same.

2. Description of the Related Art

In the fabrication process of an advanced semiconductor product, the degree of micropatterning is increased by mainly increasing the resolution of an exposure apparatus. The resolution of an exposure apparatus is determined by the wavelength of exposure light and the numerical aperture (NA) of a projection lens; the shorter the wavelength and the higher the NA, the higher the resolution. Recently, deep ultraviolet light having a wavelength of 193 nm is used. Also, although a theoretically highest value of the NA in atmosphere is 1, an immersion exposure apparatus in which the NA is increased to 1.35 by filling water between a projection lens and a substrate to be processed has been put to practical use in order to obtain a higher NA. Presently, to meet demands for further increasing the degree of micropatterning, extreme ultraviolet (EUV) lithography using EUV light having a wavelength of 13.5 nm as a light source is being examined. However, this technique is still in the research stage, and there are many problems to be solved to put the technique to practical use.

On the other hand, imprint lithography is also attracting attention as one of the next micropattern formation techniques (Jpn. Pat. Appln. KOKAI Publication No. 2007-150053). Imprint lithography is a technique by which a mold (also called a template, master, or stamper) having a concave and convex pattern corresponding to a pattern to be transferred is preformed, and the concave and convex pattern of this mold is brought into contact with an imprinting agent formed on a substrate to be processed, thereby transferring the pattern to be formed onto the imprinting agent. Imprint lithography is classified into, e.g., optical (UV) imprinting or thermal imprinting in accordance with the type (curing method) of imprinting agent.

Optical imprint lithography includes the step of coating a substrate to be processed with a photocuring imprinting agent, the (alignment) step of aligning this substrate with a light-transmitting mold, the step of bringing the mold into contact with the photocuring imprinting agent, the step of curing the photocuring imprinting agent by light irradiation in this state, and the (release) step of releasing the mold from the cured photocuring imprinting agent (resist pattern).

Unfortunately, the conventional imprint lithography has the following problems. That is, when the mold is released, the imprinting agent breaks and remains in the concave and convex pattern of the mold, thereby causing a so-called mold defect. If this defect once occurs, the defect repeats because the next imprinting (shot) is performed using the same mold in imprint lithography, and this worsens the yield. In addition, it is difficult to remove the imprinting agent remaining in the concave and convex pattern of the mold if no appropriate cleaning is performed.

### BRIEF SUMMARY OF THE INVENTION

According to a first aspect of the invention, there is provided an imprint mold comprising: a substrate; a concave and convex pattern provided on the substrate and corresponding to a pattern to be transferred; and a gas permeable region having higher gas permeability than molten quartz in which impurities are not doped.

According to a second aspect of the invention, there is provided a pattern forming method comprising: applying imprint agent on a substrate; contacting an imprint mold on the imprint agent applied on the substrate, wherein the imprint mold comprises a substrate, a concave and convex pattern provided on the substrate and corresponding to a pattern to be transferred, and a gas permeable region having higher gas permeability than molten quartz in which impurities are not doped; hardening the imprint agent in a state that the imprint mold is contacted on the imprint agent; and separating the imprint mold from the imprint agent which is hardened.

### BRIEF DESCRIPTION OF THE SEVERAL VIEWS OF THE DRAWING

FIG. 1 is a view showing the positional relationship between a mold, a concave and convex pattern of the mold, an imprinting agent applied on a substrate to be processed, and light for curing the imprinting agent;

FIG. 2 is a sectional view for explaining a pattern formation method of the first embodiment;

FIG. 3 is a sectional view for explaining the pattern formation method of the first embodiment following FIG. 2;

FIG. 4 is a sectional view for explaining the pattern formation method of the first embodiment following FIG. 3;

FIG. 5 is a sectional view for explaining the pattern formation method of the first embodiment following FIG. 4;

FIG. 6 is a sectional view for explaining the pattern formation method of the first embodiment following FIG. 5;

FIG. 7 is a sectional view for explaining a pattern formation method of the second embodiment;

FIG. 8 is a sectional view for explaining the pattern formation method of the second embodiment;

FIG. 9 is a sectional view for explaining a pattern formation method of the third embodiment;

FIG. 10 is a sectional view for explaining a pattern formation method of the fourth embodiment;

FIGS. 11A to 11C are sectional views for explaining a mold formation method of the fourth embodiment;

FIG. 12 is a sectional view for explaining a pattern formation method of the fifth embodiment;

FIGS. 13A to 13C are sectional views for explaining a mold formation method of the fifth embodiment;

FIG. 14 is a sectional view for explaining a pattern formation method of the sixth embodiment;

FIGS. 15A to 15D are sectional views for explaining a mold formation method of the sixth embodiment;

FIGS. 16A to 16D are sectional views for explaining another mold formation method of the sixth embodiment;

FIGS. 17A and 17B are sectional views for explaining a mold and mold formation method of the seventh embodiment;

FIGS. 18A and 18B are sectional views for explaining a mold and mold formation method of the eighth embodiment;

FIGS. 19A to 19D are sectional views for explaining a pattern formation method of the ninth embodiment;

FIGS. 20A to 20C are sectional views for explaining a pattern formation method of the 10th embodiment;

FIGS. 21A to 21C are sectional views for explaining a pattern formation method of the 11th embodiment;

FIGS. 22A and 22B are sectional views for explaining the principle of a cleaning method of the 12th embodiment; and

FIG. 23 is a flowchart for explaining a pattern formation method of the 12th embodiment.

### DETAILED DESCRIPTION OF THE INVENTION

Embodiments will be explained below with reference to the accompanying drawing.

### First Embodiment

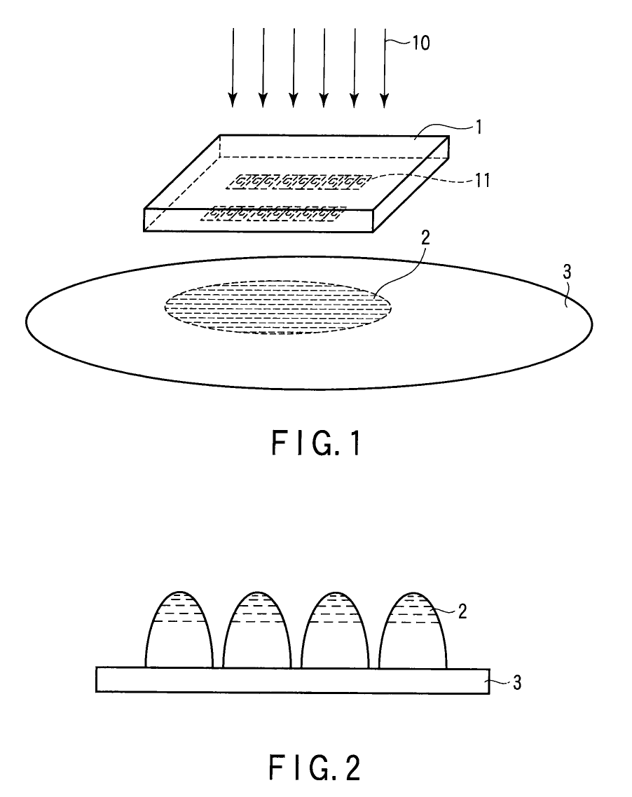

FIG. 1 is a view showing the positional relationship between a mold 1 for optical imprinting, a concave and convex pattern 11 formed on the mold 1 and corresponding to a pattern to be transferred, an imprinting agent 2 coated on a substrate 3 to be processed, and light 10 for curing the imprinting agent 2. FIGS. 2 to 6 are sectional views for explaining a pattern formation method of this embodiment. These sectional views are equivalent to side views of FIG. 1.

### [FIG. 2]

The imprinting agent 2 is applied on the substrate 3 to be processed.

In this embodiment, the imprinting agent 2 is a photocuring resin (photocuring imprinting agent). Also, in this embodiment, the imprinting agent 2 is applied shot by shot by an inkjet method. Note that the method of this embodiment is also applicable to a method by which the entire surface of the substrate 3 is coated with the imprinting agent 2 by spin coating.

The substrate 3 to be processed is a semiconductor substrate such as a silicon substrate or SOI substrate. The substrate 3 may also have a multilayered structure. As an example, the substrate 3 may also have a structure including the above mentioned semiconductor substrate and a conductive film or insulating film formed on the substrate (i.e., the substrate 3 may also be a multilayered substrate to be processed). The conductive film is, e.g., a metal film serving as an interconnection or a polysilicon film serving as a gate electrode. The insulating film is, e.g., a silicon nitride film or silicon oxide film serving as a hard mask.

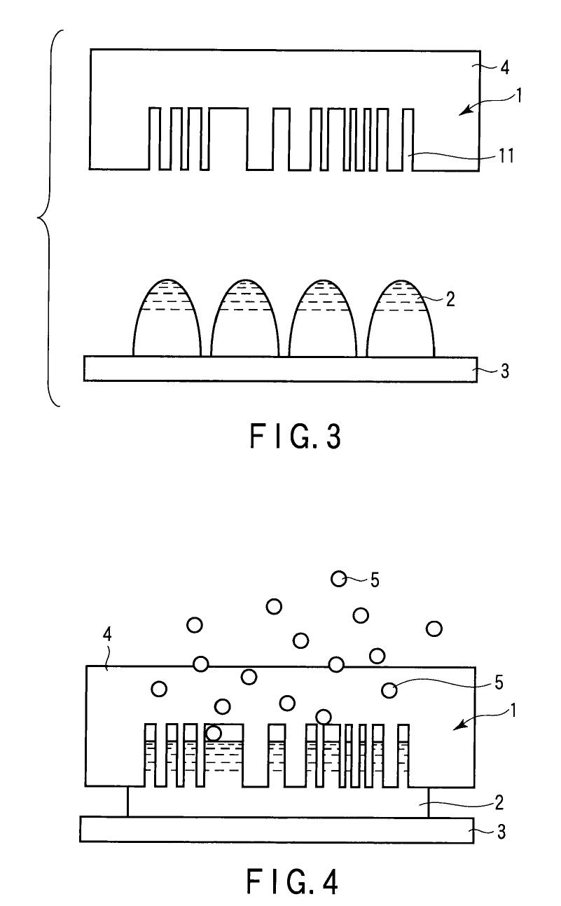

### [FIG. 3]

The mold 1 and substrate 3 to be processed are aligned (alignment).

The mold 1 of this embodiment differs from conventional molds in the following respect.

That is, the mold 1 of this embodiment has a gas permeable region 4 through which a gas can permeate. The above-mentioned gas is an inert gas such as helium (He). The pore size of the gas permeable region 4 is smaller than molecules forming the imprinting agent 2. That is, the gas permeable region 4 of this embodiment has no such large pores as those of a silicon porous material. Accordingly, the imprinting agent 2 supposed to penetrate into recesses of the concave and convex pattern 11 does not penetrate into the gas permeable region 4.

In this embodiment, an example in which the whole of the mold 1 is the gas permeable region 4 will be explained. The gas permeability of the gas permeable region 4 is higher than that of molten quartz at the same temperature (e.g., room temperature).

A mold structure in which the whole of the mold 1 is the gas permeable region 4 as described above can be implemented by using a gas permeable material as the mold material. An example is quartz doped with impurities. In a material of this kind, some atoms forming quartz are substituted with the impurities, and the lattice spacing increases. This makes the permeability higher than that of molten quartz doped with no impurities.

The expansion coefficient of quartz is small even when impurities are doped. Therefore, the use of the impurity-doped quartz as the mold material is advantageous in imprint lithography because the influence of misalignment caused by thermal expansion of the mold 1 can be reduced. The aforementioned impurity-doped quartz is also suitable as the material (light-transmitting material) of the mold 1 to be used in optical imprinting because the main component is quartz.

Other examples of the mold material as a material into which the imprinting agent does not penetrate are porous materials such as porous glass and porous ceramic, a monomer mixture in which the inter molecular spacing is larger than a gas molecule that permeates through the mold, and a resin of a copolymer.

The mold structure including the gas permeable region may also be formed by modifying, when forming a mold, molten quartz conventionally used as a mold material without doping any impurities to the quartz. This gives the mold a structure that allows the permeation of a gas but inhibits the penetration of the imprinting agent. An example of the modification process is to adjust the heating/cooling conditions when forming the quartz.

### [FIG. 4]

The concave and convex pattern of the mold 1 is brought into contact with the imprinting agent 2 on the substrate 3 to be processed, and brought closer to the substrate 3 after that. This state is held for a predetermined time so that the liquid imprinting agent 2 fills the recesses of the concave and convex pattern of the mold 1.

Since the mold 1 has the gas permeable region 4, a gas 5 can be taken into the mold 1 from a surface (back surface) opposite to the surface (concave and convex pattern surface) in contact with the imprinting agent 2. Consequently, the degree of vacuum between the mold 1 and imprinting agent 2 becomes lower than the conventional vacuum degree.

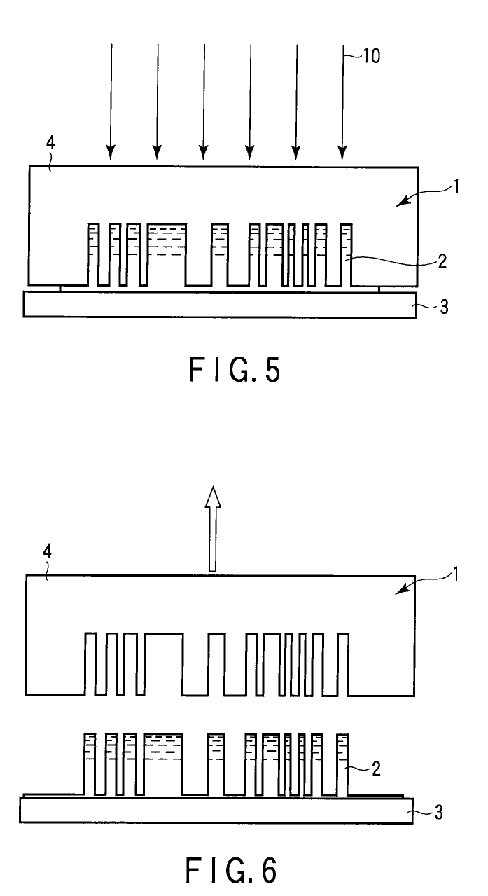

### [FIG. 5]

After the above-mentioned state is held for the predetermined time, the imprinting agent 2 is irradiated with the (UV) light 10 from the back surface (back plane) of the mold 1 while the concave and convex pattern of the mold 1 is in contact with the imprinting agent 2, thereby curing (hardening) the imprinting agent 2.

### [FIG. 6]

The mold 1 is released from the cured imprinting agent 2 (release).

In this state, the vacuum degree between the mold 1 and imprinting agent 2 is lower than the conventional vacuum degree. This makes it possible to suppress the occurrence of a so-called mold defect (resist pattern release defect) by which the cured imprinting agent 2 partially breaks and remains in a recess of the concave and convex pattern of the mold 1.

After the release step shown in FIG. 6, a pattern can be formed on the substrate 3 by performing a known etching step and other known steps. The known etching step and other steps will briefly be explained below.

In the etching step, the residual film (imprinting agent 2) on the substrate 3 to be processed is mainly removed by, e.g., oxygen plasma anisotropic etching, thereby forming a resist pattern made of the cured imprinting agent 2. In addition, this resist pattern is used as a mask to perform processing such as ion implantation to the substrate 3 or etching of the substrate 3.

Examples of the other steps are the testing step of testing a pattern defect and the step of removing the resist pattern (imprinting agent 2), both of which are performed after the release step.

The above-described steps are performed for remaining shot regions as well. As described previously, this embodiment can suppress the occurrence of a mold defect. Even when the next imprinting (shot) is performed by using the same mold 1, therefore, the decrease in yield caused by the repetition of a mold defect can be reduced. Also, the frequency of cleaning of the mold 1 can be decreased because a mold defect can be suppressed. This increases the productivity.

After that, an upper pattern layer is formed as needed. When the patterns are completely formed on one substrate to be processed, the process proceeds to a sequence of forming patterns on remaining substrates to be processed by the same method.

In this embodiment as described above, the use of the mold 1 through which a gas permeates decreases the force acting between the cured imprinting agent 2 and mold 1. In the release step, therefore, it is possible to prevent the imprinting agent 2 from partially remaining in recesses of the mold 1, thereby reducing mold defects and increasing the yield and productivity.

### Second Embodiment

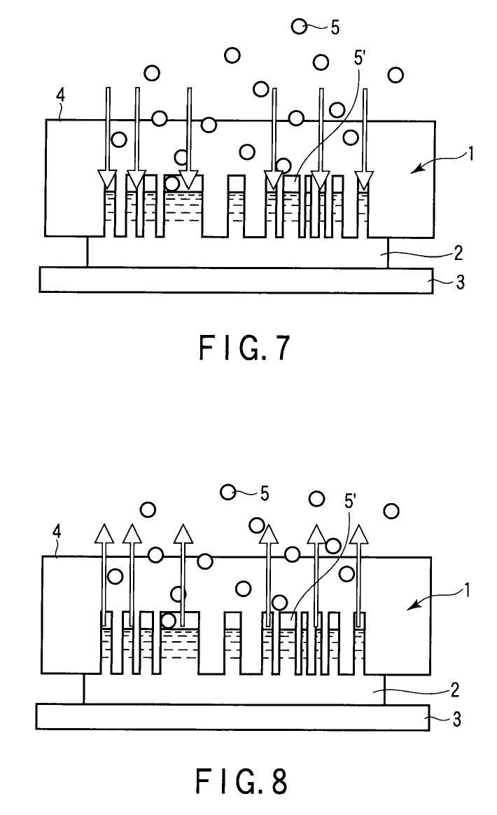

FIGS. 7 and 8 are sectional views for explaining a pattern formation method according to the second embodiment of the present invention. Note that the same reference numerals as in the above-mentioned drawing denote the same parts in the following drawing, and a repetitive explanation will be omitted.

The difference of this embodiment from the first embodiment is to positively control a gas permeating through a mold 1.

FIG. 7 shows a method by which in the step of releasing the mold 1, the ambient pressure on the upper surface of the mold 1 is made higher than that between the mold 1 and an imprinting agent 2, and the pressure between the mold 1 and imprinting agent 2 is raised by injecting a gas 5 between them so as to force the cured imprinting agent 2 out of the mold 1, thereby more effectively suppressing the occurrence of a mold defect.

FIG. 8 shows a method by which in the step of filling the imprinting agent 2 in a concave and convex pattern of the mold 1, the ambient pressure on the upper surface of the mold 1 is made lower than that between the mold 1 and imprinting agent 2, and the gas 5 remaining between the mold 1 and imprinting agent 2 is discharged through the mold 1, thereby increasing the filling rate of the imprinting agent 2.

### Third Embodiment

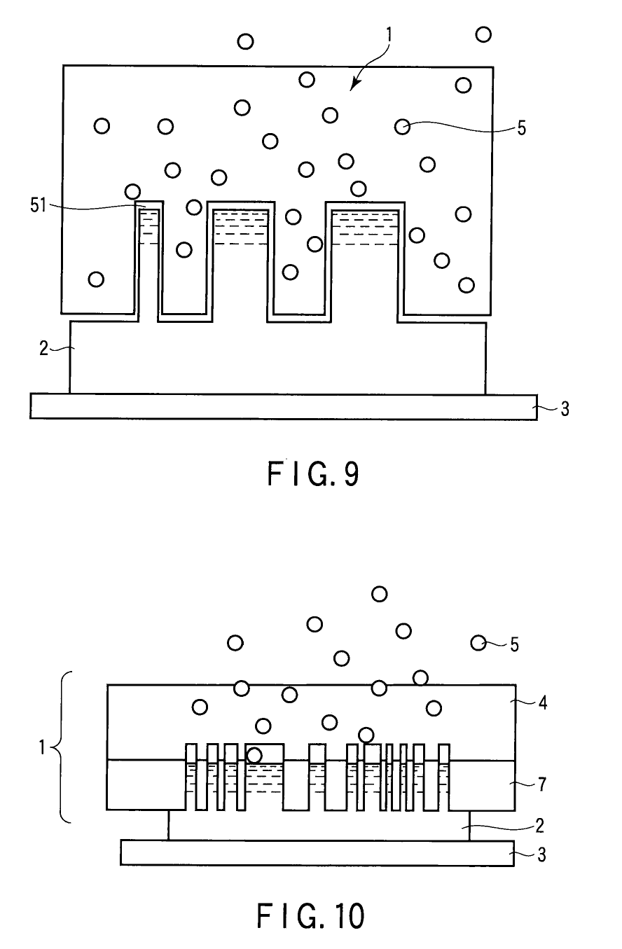

FIG. 9 is a sectional view for explaining a pattern formation method according to the third embodiment of the present invention.

The difference of this embodiment from the first embodiment is to use a mold 1 containing a gas 5 to such an extent that the gas 5 is saturated. Since the mold 1 containing the gas 5 is used, the gas 5 in the mold 1 leaks in the step of filling an imprinting agent 2, thereby forming a gas layer 51 between the mold 1 and imprinting agent 2. This makes it possible to prevent the imprinting agent 2 from partially remaining in recesses of the mold 1, and obtain the same effect as that of the first embodiment. The method of this embodiment has the advantage that even when the gas permeability of the mold 1 itself is low, the occurrence of a mold defect can effectively be suppressed by the assistance of the gas layer 51.

The same effect can also be obtained by forming the gas layer 51 between the mold 1 and imprinting agent 2 by holding the gas pressure around the mold 1 to such an extent that the gas is saturated, or by bringing the mold 1 into contact with the imprinting agent 2 while applying a gas pressure slightly higher than that in the saturated state to the mold 1.

When the gas permeability is high, it is possible to obtain the effect of increasing the filling rate by reducing the gas pressure during imprinting. When the gas permeability of the mold 1 is low, however, it is possible to obtain the effect of suppressing a release defect by performing imprinting while increasing the gas pressure such that the gas slightly leaks from the surface.

### Fourth Embodiment

FIG. 10 is a sectional view for explaining a pattern formation method according to the fourth embodiment of the present invention.

This embodiment differs from the first embodiment in that a mold 1 is not entirely but partially a gas permeable region 4. In this embodiment, the gas permeable region 4 is formed from the back surface side having no concave and convex pattern to a portion slightly overlapping a concave and convex pattern, and the rest of the concave and convex pattern is a gas non-permeable region 7. The gas non-permeable region 7 is made of, e.g., the same material as that of the conventional mold 1.

In this embodiment, the side surfaces of the concave and convex pattern are surrounded by the gas non-permeable region 7, so a gas 5 does not enter or leave the side surfaces of the concave and convex pattern. In the release step, therefore, projections of a cured imprinting agent 2 do not receive any pressure from the side surfaces of the concave and convex pattern. This pressure from the side surfaces functions as a force that constricts the projections of the cured imprinting agent 2, thereby causing resist break. Accordingly, the projections of the cured imprinting agent 2 receive a pressure from the upper surface but does not receive any pressure from the side surfaces. That is, the cured imprinting agent 2 is pushed out while maintaining its shape. This makes it possible to more effectively suppress the occurrence of a mold defect in the release step.

Note that the method of this embodiment may also be combined with the methods (FIGS. 7 and 8) described in the second embodiment. When the method of this embodiment is combined with the method shown in FIG. 7, the gas 5 is positively injected between the mold 1 and imprinting agent 2 in the release step, so the effect (of suppressing a mold defect) of this embodiment increases. On the other hand, when the method of this embodiment is combined with the method shown in FIG. 8, the gas 5 remaining between the mold 1 and imprinting agent 2 is positively discharged, so the filling rate of the imprinting agent 2 can be increased.

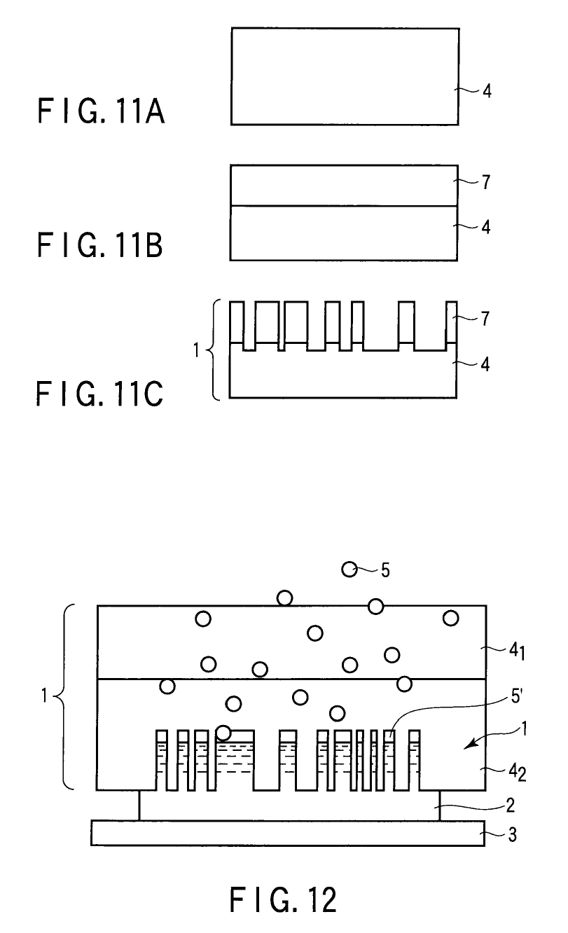

FIGS. 11A to 11C are sectional views for explaining a mold formation method of this embodiment.

First, as shown in FIG. 11A, a substrate (gas permeable region) 4 made of a gas permeable material is prepared.

Then, as shown in FIG. 11B, a gas non-permeable region 7 is formed on the substrate (gas permeable region) 4. More specifically, the gas non-permeable region 7 is formed by adhering a gas non-permeable substrate having a predetermined thickness on the substrate (gas permeable region) 4, depositing a gas non-permeable material on the substrate (gas permeable region) 4 until a predetermined thickness is obtained, or melting the concave and convex pattern formation surface of the substrate (gas permeable region) 4 by heating.

Finally, as shown in FIG. 11C, a resist pattern (not shown) formed on the gas non-permeable region 7 is used as a mask to etch the gas non-permeable region 7 and substrate (gas permeable region) 4, and form a concave and convex pattern whose recesses have bottoms in the gas permeable region 4, thereby obtaining the mold 1.

### Fifth Embodiment

FIG. 12 is a sectional view for explaining a pattern formation method according to the fifth embodiment of the present invention.

The difference of this embodiment from the first embodiment is to use a mold 1 including first and second gas permeable regions 4₁ and 4₂ different in gas permeability.

The gas permeability of the first gas permeable region 4₁ is higher than that of the second gas permeable region 4₂. The back surface side of the mold 1 which includes no concave and convex pattern is the first gas permeable region 4₁. The rest of the mold 1 which includes a concave and convex pattern is the second gas permeable region 4₂.

The mold 1 as described above can be implemented by forming the first gas permeable region 4₁ by using a material (first material) having high gas permeability, and forming the second gas permeable region 4₂ by using a material (second material) having low gas permeability. The main components of the first and second materials can be the same. Examples are materials mainly containing quartz and having gas permeability controlled by changing the type or amount of impurity to be doped.

Assuming that the gas permeability of the first gas permeable region 4₁ is higher than that of the gas permeable region 4 of the first embodiment and the gas permeability of the second gas permeable region 4₂ is the same as that of the gas permeable region 4 of the first embodiment, the response of a gas in the mold 1 to a pressure from the back surface of the mold 1 in this embodiment is faster than that in the first embodiment.

If the total thickness of the first and second gas permeable regions 4₁ and 4₂ is the same as the thickness of the gas permeable region 4 of the first embodiment, the response speed increases by an amount corresponding to the thickness of the first gas permeable region 4₁.

Also, even when the total thickness of the first and second gas permeable regions 4₁ and 4₂ is larger than the thickness of the gas permeable region 4 of the first embodiment, the response speed can be increased by adjusting the ratio of the thickness of the first gas permeable region 4₁ to that of the second gas permeable region 4₂.

As described above, this embodiment can improve the response of the gas in the mold 1 to the pressure from the back surface of the mold 1. Accordingly, the filling rate of an imprinting agent 2 can be increased in the imprinting agent filling step, and the release speed of the mold 1 can be increased in the release step.

Furthermore, when the gas permeable region 4₂ including the concave and convex pattern is made of a material having high gas permeability and low strength and the gas permeable region 4₁ including no concave and convex pattern is made of a material having low gas permeability and high strength, it is possible to increase the filling rate and release speed, and prolong the life of the mold because the mold strength can be held high.

If the gas permeable regions 4₁ and 4₂ have strength anisotropy, the gas permeable regions 4₁ and 4₂ are arranged to make the directions of strength different, thereby reducing the direction in which the mold is weak as a whole. This makes it possible to prolong the life of the mold 1.

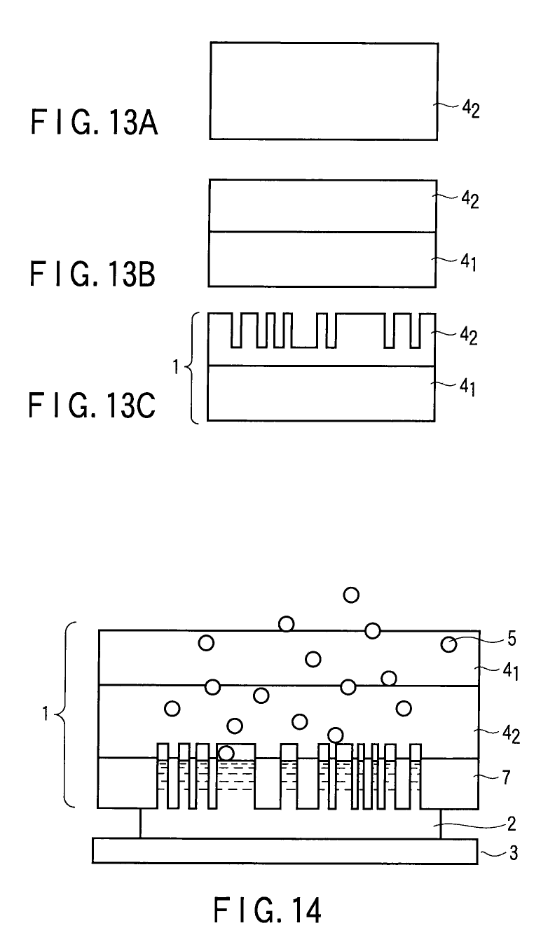

FIGS. 13A to 13C are sectional views for explaining a mold formation method of this embodiment.

First, as shown in FIG. 13A, a substrate (second gas permeable region) 4₂ made of a low gas permeability material is prepared.

Then, as shown in FIG. 13B, a first gas permeable region 4₁ made of a high gas permeability material is formed on the substrate (second gas permeable region) 4₂. More specifically, the first gas permeable region 4₁ is formed by adhering a high gas permeability substrate having a predetermined thickness on the substrate (second gas permeable region) 4₂ such that the gas permeability does not deteriorate on the adhesion surface, depositing a high gas permeability material on the substrate (second gas permeable region) 4₂ until a predetermined thickness is obtained, or heating the surface of the substrate (second gas permeable region) 4₂ opposite to the concave and convex pattern formation surface.

Finally, as shown in FIG. 13C, a resist pattern (not shown) is used as a mask to etch the substrate (second gas permeable region) 4₂ and form a concave and convex pattern, thereby obtaining the mold 1.

### Sixth Embodiment

FIG. 14 is a sectional view for explaining a pattern formation method according to the sixth embodiment of the present invention.

The difference of this embodiment from the first embodiment is to use a mold 1 including first and second gas permeable regions 4₁ and 4₂ and a gas non-permeable region 7. That is, this embodiment is a combination of the fourth and fifth embodiments.

In this embodiment, the gas permeable regions 4₁ and 4₂ are formed from the back surface side having no concave and convex pattern to a portion slightly overlapping a concave and convex pattern, and the rest of the concave and convex pattern is the same gas non-permeable region 7 as that of the conventional mold. The gas non-permeable region 7 is made of, e.g., the same material as that of the conventional mold 1.

Similar to the fourth embodiment, the effect of suppressing a mold defect can be obtained because no pattern constricting force is applied. In addition, the non-pattern portion of the mold is made of two or more types of gas permeable materials. As described in the fifth embodiment, therefore, the response when the gas pressure is controlled becomes faster. This makes it possible to increase the imprinting agent filling rate and release speed, and prolong the life of the mold by increasing the mold strength.

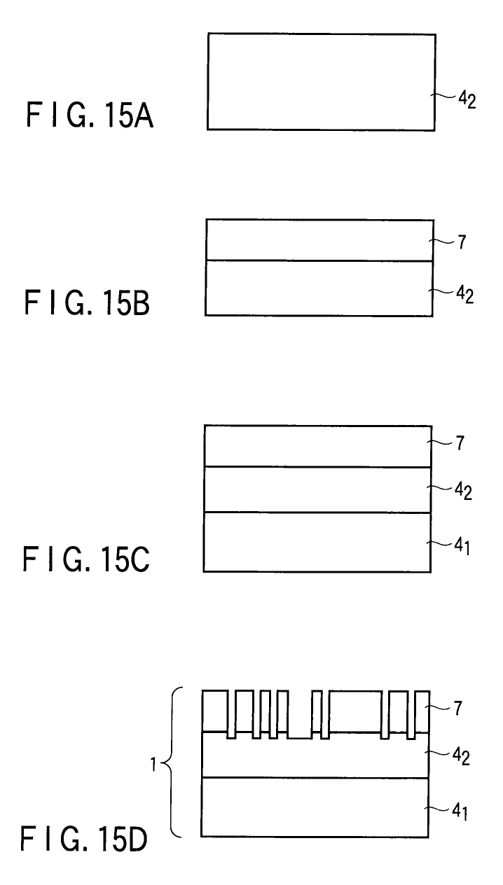

FIGS. 15A to 15D are sectional views for explaining a mold formation method of this embodiment.

First, as shown in FIG. 15A, a substrate (second gas permeable region) 4₂ made of a low gas permeability material is prepared.

Then, as shown in FIG. 15B, a gas non-permeable region 7 is formed on the substrate (second gas permeable region) 4₂. More specifically, the gas non-permeable region 7 is formed by adhering a gas non-permeable substrate having a predetermined thickness on the substrate (second gas permeable region) 4₂, depositing a gas non-permeable material on the substrate (second gas permeable region) 4₂ until a predetermined thickness is obtained, or melting the concave and convex pattern formation surface of the substrate (second gas permeable region) 4₂ by heating.

Subsequently, as shown in FIG. 15C, a first gas permeable region 4₁ made of a high gas permeability material is formed on the surface (back surface) of the substrate (second gas permeable region) 4₂ opposite to the surface on which the gas non-permeable region 7 is formed. More specifically, the first gas permeable region 4₁ is formed by adhering a high gas permeability substrate having a predetermined thickness on the substrate (second gas permeable region) 4₂ such that the gas permeability does not deteriorate on the adhesion surface, depositing a high gas permeability material on the substrate (second gas permeable region) 4₂ until a predetermined thickness is obtained, or heating the surface of the substrate (second gas permeable region) 4₂ opposite to the concave and convex pattern formation surface.

Finally, as shown in FIG. 15D, a resist pattern (not shown) formed on the gas non-permeable region 7 is used as a mask to etch the gas non-permeable region 7 and substrate (second gas permeable region) 4₂, and form a concave and convex pattern whose recesses have bottoms in the substrate (second gas permeable region) 4₂, thereby obtaining the mold 1.

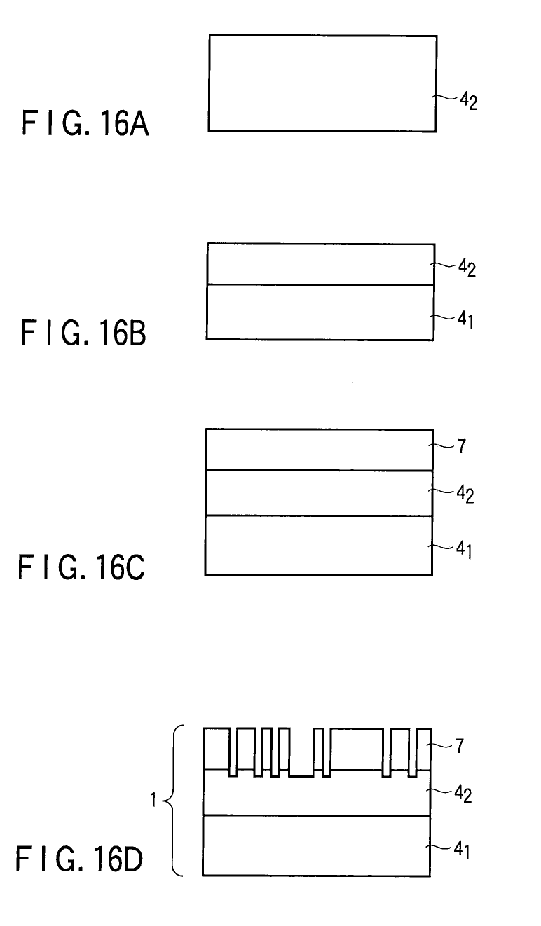

FIGS. 16A to 16D are sectional views for explaining another mold formation method of this embodiment. The difference of this formation method from the above-mentioned formation method (FIGS. 15A to 15D) is to form the gas non-permeable region 7 after the first gas permeable region 4₁ is formed. It is also possible to appropriately change the formation order of the first gas permeable region 4₁, second gas permeable region 4₂, and gas non-permeable region 7.

### Seventh Embodiment

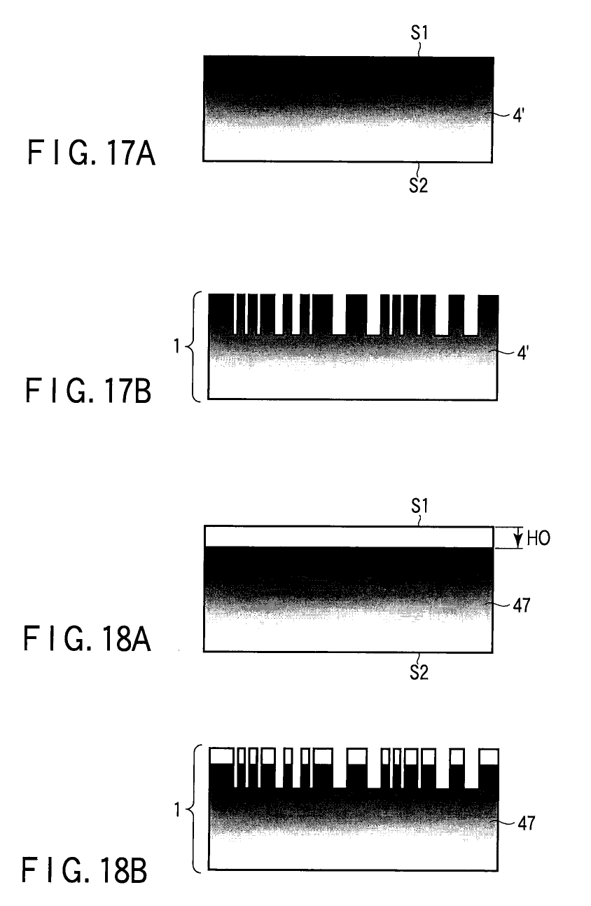

FIGS. 17A and 17B are sectional views for explaining a mold and mold formation method according to the seventh embodiment of the present invention.

First, as shown in FIG. 17A, a substrate (gas permeable region) 4′ in which the gas permeability is low on an upper surface S1 and gradually increases from the upper surface S1 to a lower surface S2 is prepared.

Then, as shown in FIG. 17B, a resist pattern (not shown) is used as a mask to etch the substrate (gas permeable region) 4′, and form a concave and convex pattern on the surface on which the gas permeability is low, thereby obtaining a mold 1.

In this embodiment, the gas permeability is high on the bottom of a recess of the concave and convex pattern. This makes it possible to obtain the same effects as those of the first embodiment, e.g., suppress a mold defect during mold release.

### Eighth Embodiment

FIGS. 18A and 18B are sectional views for explaining a mold and mold formation method according to the eighth embodiment of the present invention.

First, as shown in FIG. 18A, a substrate (gas non-permeable/permeable region) 47 in which the gas permeability is zero from an upper surface S1 to a predetermined depth H0 and gradually increases toward a lower surface (rear surface) S2 after that is prepared.

Then, as shown in FIG. 18B, a resist pattern (not shown) is used as a mask to etch the substrate (gas non-permeable/permeable region 47), and form a concave and convex pattern on the surface having no gas permeability, thereby obtaining a mold 1.

In this embodiment, the top (distal end) of a projection of the concave and convex pattern has no gas permeability. This makes it possible to avoid the generation of a pressure that sideways constricts the root of an imprinting agent projecting pattern formed on a substrate to be processed. During mold release, therefore, a mold defect can be suppressed more effectively than in the seventh embodiment.

### Ninth Embodiment

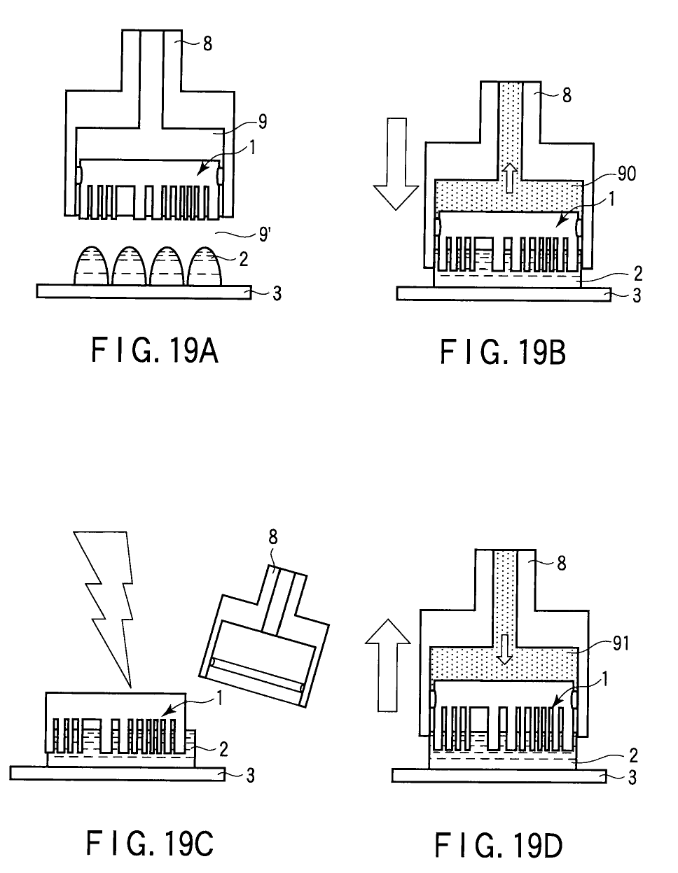

FIGS. 19A to 19D are sectional views for explaining a pattern formation method according to the ninth embodiment of the present invention.

In this embodiment, a method and means for controlling the ambient pressure on the upper surface of a mold 1 will be explained in detail. This embodiment is also applicable to any of the molds 1 described previously.

First, as shown in FIG. 19A, a substrate 3 to be processed is coated with an imprinting agent 2 by a known method, and the mold 1 is placed on the substrate 3 and aligned.

In this state, the mold 1 is fixed on a mold stage (not shown), and the mold stage is held by a mold stage holding mechanism 8.

The mold stage holding mechanism 8 is made of a hard material capable of isolating an ambient 9 on a surface (outside the mold) opposite to the concave and convex pattern surface (plane) of the mold 1 from an ambient 9′ in recesses (inside the mold) of the concave and convex pattern of the mold 1, thereby holding the pressure difference between the ambients 9 and 9′. Examples of the hard material are a metal, ceramic, and glass. The ambient 9 on the upper surface of the mold 1 is an inert gas such as He.

Also, the mold stage holding mechanism 8 is connected to a driving mechanism (not shown). This driving mechanism vertically drives the mold stage holding mechanism 8.

Then, as shown in FIG. 19B, the driving mechanism moves down the mold stage holding mechanism 8 to bring the mold 1 into contact with the imprinting agent 2.

In this state, a pressure control mechanism (evacuating means) (not shown) controls a pressure (mold upper surface side pressure) 90 in the space defined by the upper surface of the mold 1 and the inner walls of the mold stage holding mechanism 8. That is, the mold upper surface side pressure 90 is lowered after the mold 1 is brought into contact with the imprinting agent 2, or the mold 1 is brought into contact with the imprinting agent 2 while the mold upper surface side pressure 90 is lowered. By thus controlling the mold upper surface side pressure 90, it is possible to effectively increase the filling rate of the imprinting agent 2, and increase the throughput.

The above-mentioned pressure control mechanism (evacuating means) (not shown) is a vacuum pump for exhausting the gas existing in the space defined by the upper surface of the mold 1 and the inner walls of the mold stage holding mechanism 8.

Subsequently, as shown in FIG. 19C, the imprinting agent 2 is cured by emitting light from the back surface side of the mold 1 (photocuring). Assume that the mold stage holding mechanism 8 does not transmit light. As shown in FIG. 19C, therefore, photocuring is performed with the mold stage holding mechanism 8 being removed.

Note that it is also possible to irradiate the mold with light from inside the mold stage holding mechanism 8 without removing it. The method of irradiating the mold with light from inside the mold stage holding mechanism has the following advantage.

In the imprinting agent application step, the imprinting agent may be applied to a region other than a shot region to be coated with the imprinting agent. However, when the mold is irradiated with light from inside the mold stage holding mechanism, the imprinting agent (excess imprinting agent) applied on the region other than the shot region is not irradiated with the light. This makes it possible to prevent the excess imprinting agent from being cured.

The excess imprinting agent is often applied on a shot region (adjacent shot region) adjacent to a shot region to be coated with the imprinting agent. It is highly likely that the adjacent shot region is a shot region to be shot next. If the excess imprinting agent is cured on the shot region to be shot next, the step of removing the cured excess imprinting agent must be added after the imprinting agent curing step.

It is, however, possible to prevent the curing of the excess imprinting agent by irradiating the mold with light from inside the mold stage holding mechanism 8 that does not transmit light. Therefore, imprinting can be repeated without performing any step of removing the cured excess imprinting agent. This makes it possible to prevent the decrease in throughput caused by the generation of the excess imprinting agent.

As shown in FIG. 19D, the mold stage holding mechanism 8 is reattached and raised by the above-described driving mechanism (not shown), thereby separating the mold 1 from the cured imprinting agent 2 (release).

In this state, a pressure control mechanism (pressurizing means) (not shown) performs control to raise a pressure (mold upper surface side pressure) 90′ in the space defined by the upper surface of the mold 1 and the inner walls of the mold stage holding mechanism 8. Since this effectively allows the gas to permeate into the mold 1, mold release can be performed more effectively.

The aforementioned pressure control mechanism (pressurizing means) (not shown) is, e.g., a gas supply device for supplying an inert gas such as He into the space defined by the upper surface of the mold 1 and the inner walls of the mold stage holding mechanism 8.

### 10th Embodiment

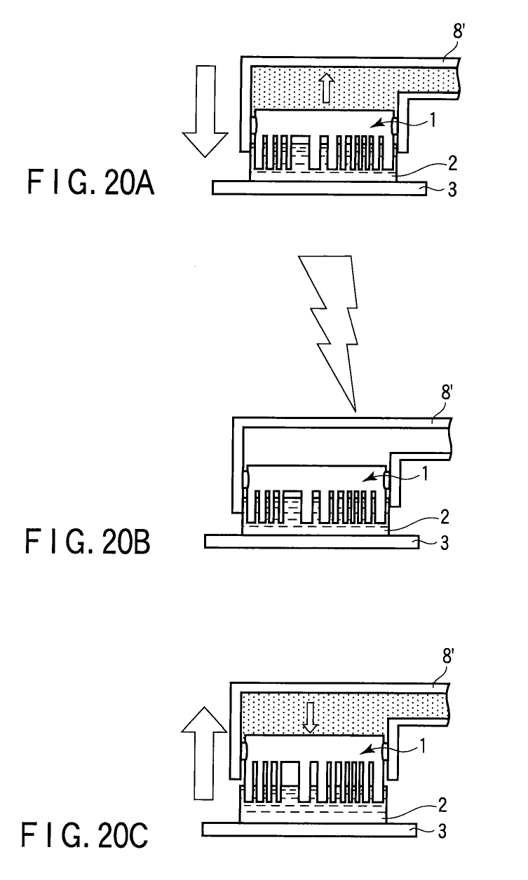

FIGS. 20A to 20C are sectional views for explaining a pattern formation method according to the 10th embodiment of the present invention. Steps shown in FIGS. 20A to 20C respectively correspond to the steps shown in FIGS. 19B to 19D of the eighth embodiment.

The difference of this embodiment from the ninth embodiment is to use a mold stage holding mechanism 8′ that transmits light. In this embodiment, therefore, in the step of curing an imprinting agent 2 shown in FIG. 20B, the mold stage holding mechanism 8′ need not be removed, and light can be emitted from above the mold stage holding mechanism 8′. Also, in the release step shown in FIG. 20C, it is unnecessary to perform the operation of reattaching the mold stage holding mechanism 8′. Accordingly, it is possible to prevent the decrease in throughput caused by the detachment/attachment of the mold stage holding mechanism 8′. Any of the molds 1 described previously can be used in this embodiment as well.

### 11th Embodiment

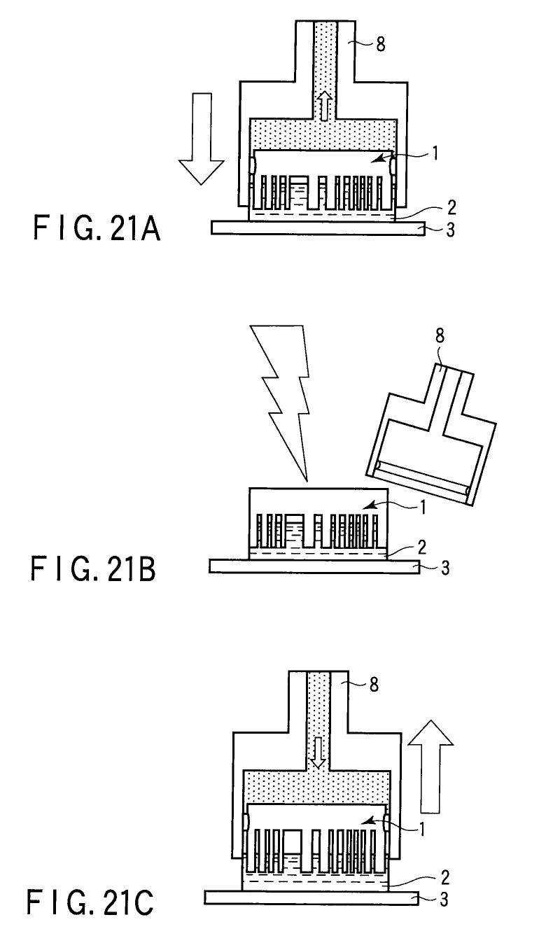

FIGS. 21A to 21C are sectional views for explaining a pattern formation method according to the 11th embodiment of the present invention. Steps shown in FIGS. 21A to 21C respectively correspond to the steps shown in FIGS. 19B to 19D of the eighth embodiment.

The difference of this embodiment from the eighth embodiment is to cure an imprinting agent 2 by heating in the curing step shown in FIG. 21B. That is, this embodiment is an example of thermal imprinting using a thermosetting imprinting agent 2. A mold stage holding mechanism 8′ may also be used instead of a mold stage holding mechanism 8. Any of the molds 1 described previously can be used in this embodiment as well.

### 12th Embodiment

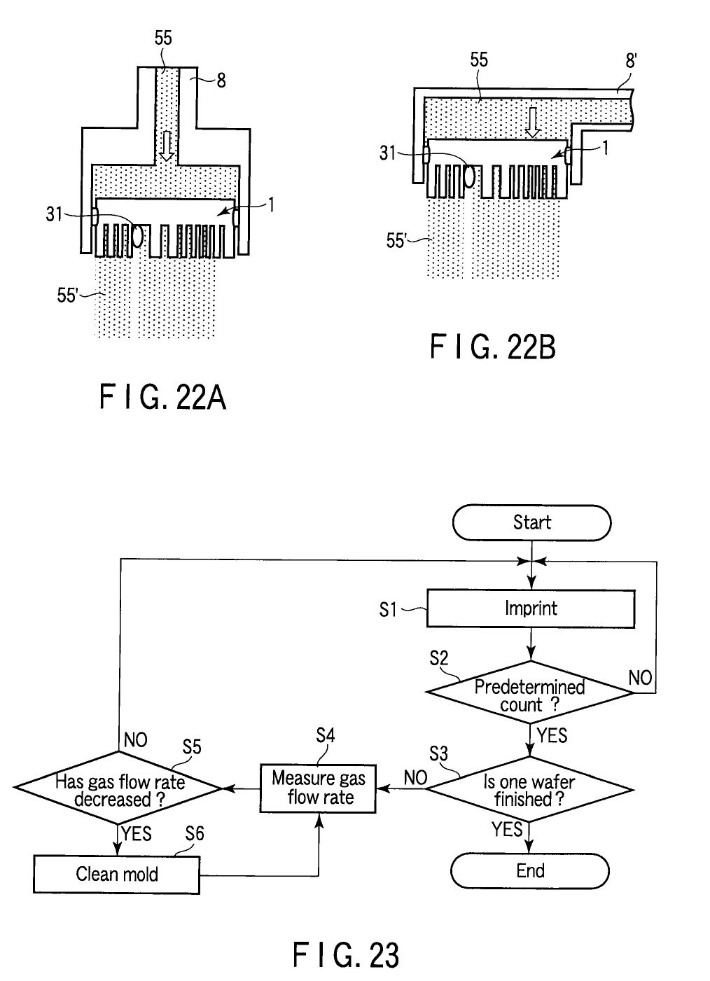

FIG. 22A shows a mold stage holding mechanism 8 described in the ninth embodiment and a mold 1 held by using it. On the other hand, FIG. 22B shows a mold stage holding mechanism 8′ described in the 10th embodiment and the mold 1 held by using it.

A gas 55 is supplied to the back surface (the surface opposite to the surface on which the concave and convex pattern is formed) of the mold 1. The gas 55 is supplied at a predetermined flow rate. The gas 55 permeates through the mold 1, and escapes from the front surface (the surface on which the concave and convex pattern is formed) of the mold 1.

The flow rate of a gas 55′ having escaped from the front surface of the mold 1 changes in accordance with the state of a mold defect 31 cured imprinting agent sticking to a recess of the concave and convex pattern); the larger the size of the mold defect 31 or the larger the number of mold defects 31, the lower the flow rate of the gas 55′.

Accordingly, the flow rate of the gas 55′ is measured, and the difference (F−F′) between a measured flow rate F′ of the gas 55′ and a predetermined flow rate F of the gas 55 is evaluated. This makes it possible to check whether the mold defect 31 has occurred without performing any troublesome pattern-level fine defect test. Accordingly, the timing of cleaning of the mold 1 can be managed.

A pattern formation method of this embodiment including the mold cleaning step based on the above finding will be explained below. FIG. 23 is a flowchart showing the pattern formation method of this embodiment.

### [Step S1]

A pattern is formed on the region of one shot by using the pattern formation method (imprinting) of the embodiment using the mold of the embodiment.

### [Step S2]

Whether the number of times of imprinting performed so far has reached a precalculated predetermined count (reference count) is checked. The reference count is the number of times of imprinting requiring mold cleaning. For example, the reference count is determined as follows. That is, a plurality of times of shot are performed using the same mold as used in step S1, and the presence/absence of a mold defect is checked for each shot. The number of times at which a mold defect is found is set as the reference count.

If it is determined in step S2 that the number of times of imprinting has not reached the reference count (NO), step S1 is reexecuted.

### [Step S3]

If it is determined in step S2 that the number of times of imprinting has reached the reference count (YES), whether the number of times of imprinting performed so far has reached a count (total count) required to process one wafer is checked.

If it is determined in step S3 that the number of times of imprinting has reached the total count (YES), imprinting of the wafer is complete.

### [Step S4]

If it is determined in step S3 that the number of times of imprinting has not reached the total count (NO), the flow rate of a gas that permeates through the mold used in step S1 is measured. This flow rate measurement is to, e.g., measure the flow rate of the gas 55′ having escaped from the front surface of the mold 1 as shown in FIGS. 22A and 22B.

### [Step S5]

Based on the gas flow rate measured in step S4, whether the flow rate of the gas that permeates through the mold has decreased is checked. This determination is done by, e.g., comparing the gas flow rate measured in step S4 with a premeasured gas flow rate (reference flow rate). The reference flow rate is, e.g., a gas flow rate checked by using the same mold as used in step S1 which has not been used in imprinting (which has no mold defect).

If it is determined in step S5 that the gas flow rate measured in step S4 is the same as the reference flow rate, it is determined that the flow rate has not decreased (NO), and the process returns to step S1.

### [Step S6]

If it is determined in step S5 that the gas flow rate measured in step S4 is lower than the reference flow rate, it is determined that the flow rate has decreased (YES), and the mold is cleaned.

Note that even when the gas flow rate measured in step S4 is lower than the reference flow rate, if the decrease falls within a predetermined range, it is possible to determine that the flow rate has not decreased.

After the mold is cleaned, the process returns t step S4. That is, it is conformed that the mold defect is removed by the cleaning, and imprinting (step S1) is reexecuted after that.

Note that the present invention is not limited to the above embodiments. For example, the location of the gas permeable region is not particularly limited as long as the following condition is met. That is, in an imprinting mold, the gas permeability in a region between the bottom of a recess of a concave and convex pattern and a surface which faces the bottom of the recess and is opposite to a surface on which the concave and convex pattern is formed need only be higher than that of quartz.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imprint mold comprising:
a substrate;
a concave and convex pattern provided on the substrate and corresponding to a pattern to be transferred; and
a gas permeable region having higher gas permeability than molten quartz in which impurities are not doped.

2. The imprint mold according to claim 1,
wherein the gas permeable region is provided in a region between a bottom of concave portion of the concave and convex pattern and a plane facing the bottom of the concave portion, the plane opposing to a plane on which the concave and convex pattern is formed.

3. The imprint mold according to claim 2,
wherein the gas permeable region has higher gas permeability than quartz.

4. The imprint mold according to claim 2,
wherein a convex portion of the concave and convex pattern has non-permeability to the gas.

5. The imprint mold according to claim 1,
wherein the gas permeable region comprises a plurality of regions having a plurality of permeabilities, the plurality of permeabilities vary toward a plane on which the concave and convex pattern is formed from a plane opposing to the plane on which the concave and convex pattern is formed

6. The imprint mold according to claim 1,
wherein the gas is inert gas.

7. The imprint mold according to claim 6,
wherein the inert gas is helium gas.

8. The imprint mold according to claim 1,
wherein size of hole of the gas permeable region is smaller than molecule constituting imprint agent used for imprinting.

9. The imprint mold according to claim 1,
wherein whole of the substrate and the concave and convex pattern are the gas permeable region.

10. The imprint mold according to claim 1,
wherein the gas permeable region is comprised of material which does not sink into imprint agent used for imprinting.

11. The imprint mold according to claim 10,
wherein the material which does not sink into imprint agent is porous material, monomer mixture having larger intermolecular distance than molecule constituting the gas, or resin of copolymer.

12. The imprint mold according to claim 1,
wherein the gas permeable region includes gas.

13. A pattern forming method comprising:
applying imprint agent on a substrate;
contacting an imprint mold on the imprint agent applied on the substrate, wherein the imprint mold comprises a substrate, a concave and convex pattern provided on the substrate and corresponding to a pattern to be transferred, and a gas permeable region having higher gas permeability than molten quartz in which impurities are not doped;
hardening the imprint agent in a state that the imprint mold is contacted on the imprint agent; and
separating the imprint mold from the imprint agent which is hardened.

14. The pattern forming method according to claim 13,
wherein the separating the imprint mold from the imprint agent which is hardened comprises injecting gas between the imprint mold and the imprint agent.

15. The pattern forming method according to claim 14,
wherein the injecting gas between the imprint mold and the imprint agent is performed by setting pressure on a top surface of the imprint mold higher than pressure of an atmosphere between the imprint mold and the imprint agent.

16. The pattern forming method according to claim 13,
wherein the hardening the imprint agent is performed by irradiating the imprint agent with light, or heating the imprint agent.

17. The pattern forming method according to claim 13,
further comprising: measuring flow rate of gas passing through the imprint mold when imprint is repeated predetermined numbers of times, and cleaning the imprint mold the measured flow rate is smaller than a reference value

18. The pattern forming method according to claim 13,
wherein the gas permeable region has higher gas permeability than quartz.

19. The pattern forming method according to claim 18,
wherein a convex portion of the concave and convex pattern has non-permeability to the gas.

20. The pattern forming method according to claim 13,
wherein the gas permeable region comprises a plurality of regions having a plurality of permeabilities, the plurality of permeabilities vary toward a plane on which the concave and convex pattern is formed from a plane opposing to the plane on which the concave and convex pattern is formed.
